(19) United States
(12) Patent Application Publication
(10) Pub. No.: US 2021/0180263 A1
(43) Pub. Date: Jun. 17, 2021

(54) Portable Weld Milling Machine Apparatus and Methods of Using the Same

(71) Applicant: Holland, L.P., Crete, IL (US)

(72) Inventors: Kelly Steck, Gig Harbor, WA (US); Paul Lindemulder, Saint John, IN (US); Benjamin Byma, Dyer, IN (US)

(21) Appl. No.: 17/182,842

(22) Filed: Feb. 23, 2021

Related U.S. Application Data
(63) Continuation-in-part of application No. 16/372,827, filed on Apr. 2, 2019, now Pat. No. 10,941,527.
Application No. 16/372,827 is a continuation of application No. 15/442,245, filed on Feb. 24, 2017, now abandoned.
(60) Provisional application No. 62/299,231, filed on Feb. 24, 2016.

(51) Int. Cl. E01B 31/13; B23Q 9/02; B23C 3/00

(52) U.S. Cl. CPC E01B 31/13; B23Q 9/02; B23C 2240/16; B23C 2215/32; B23C 3/005

(57) ABSTRACT

A portable rail weld milling machine apparatus comprises a support structure comprising a milling tool, wherein the milling tool comprises a milling head for milling a railroad rail by moving the milling tool in a first direction longitudinal to parallel railroad rails, in a second direction lateral to the parallel railroad rails, and a third direction vertically.

The present invention claims priority as a continuation-in-part to U.S. patent application Ser. No. 16/372,827, titled “Portable Rail Weld Milling Machine Apparatus and Methods of Using the Same,” filed Apr. 2, 2019, which claims priority to U.S. patent application Ser. No. 15/442,245, titled “Portable Weld Milling Machine Apparatus and Methods of Using the Same,” filed Feb. 24, 2017, which claims priority under 35 U.S.C. 119 to U.S. Prov. Pat. App. No. 62/299,231 titled, “Portable Rail Weld Milling Machine Apparatus and Methods of Using the Same,” filed Feb. 24, 2016, each of which is incorporated by reference herein in its entirety.

### TECHNICAL FIELD

The present disclosure provides a portable rail weld milling machine apparatus. Specifically, the portable rail weld milling machine apparatus comprises a frame or support structures that incorporates a motor with a rotary carbide tool that is able to lock to a rail or rails for stability. The apparatus houses the required guides and motors to maneuver the tool on a plurality of axes with computer numerical control (“CNC”). The CNC programming is able to control the carbide tool such that the welded rail can be milled to proper profile on the entire running surface, including the top, the field side, and the gauge side of the ball of the rail.

### BACKGROUND

Railway rails form a complex web across the United States and the world and are heavily used for transportation of goods and people. Typically, railway transport consists of a track, typically made of parallel steel rails with many cross-ties, on which rolling stock moves. Commonly, rail vehicles known as trains include fixed metal wheels of a specific gauge that engage the parallel rails and move thereon. As the rails are used and age, they must frequently be repaired and/or replaced.

A common way to repair rail lines is to remove a section of a rail to either fix the section or to replace the section with new rail. To do so, a cutting saw typically cuts the rail at specific locations so that the section can be removed. When the section of rail is repaired or when a replacement section is added back, the terminal ends of the section of the rail must be welded to the remaining rail. The weld must simultaneously be strong enough to withstand the pressures of use, and have a profile that allows for the smooth rolling of stock thereon. Indeed, irregularities in the head of a rail may interfere with the proper rolling of rail vehicles thereon.

Rail sections are typically welded together in what is known as a “flash butt-weld,” where the terminal sections of rail are abutted to one another, and an arc is drawn between the rail sections causing the ends to melt followed by an axial force, or forging, of the ends together. The forging process forces the excess molten metal out of the joint leaving a bead, or flashing, around the profile of the rail. Alternatively, the rail ends can be joined by an exothermic process whereby a mold is placed around the rail ends and metal is melted over the mold allowing metal to flow into the joint to close the gap between. The exothermic process leaves a flashing around the joint after the molds are removed. In either process, the flashing may or may not be partially removed with a shearing die. The weld flashing, whether sheared or not, tends to be irregular and bumpy in shape and must be smoothed to a smooth running surface that matches the specified running and side surfaces of the rest of the rail.

To smooth the head of a rail, grinding machines are used, typically consisting of rotary tools having grinding stones thereon. Specifically, rail grinding machines comprise a grinding head carrying an abrasive grinding stone mounted to rotate about an axis. Further, rail grinding machines may be capable of up and down movement parallel to its axis of rotation. The rotating stone is lowered to create contact with the rail head, and is typically continually adjusted while being manually moved back and forth in the longitudinal direction of the rail. The rotary grinding tool is often contained within a chassis that is pivoted about a longitudinal axis to restore the rail head profile of the field side and the gauge side of the rail head. Moreover, the chassis and grinding head carried by the chassis may be inclined at will to one side of the rail or the other, starting from a substantially vertical starting position, so as to allow the top face or sides of the rail head to be ground. Oftentimes, the operation of existing rail grinding machines tend to force the operator into an awkward position and placed an undesirable amount of stress on his or her shoulders and back region, causing fatigue over time and enhancing the likelihood of improper restoration of the rail profile. Moreover, using rotary grinding tools in the manner described above may cause the production of a large of amount of sparks that can be thrown in multiple directions, increasing the likelihood of injury and/or damage caused by fire.

The rail grinding machines are designed to grind the head of a rail with the intent of restoring profile of the weld region to match the balance of the length of the rails. Usually, rail profile grinding operations affect both the top face of the rail and the two sides of the rail head (the field side and the gauge side thereof). A need, therefore, exists for an improved apparatus for restoring a rail profile after welding of the same. More specifically, a need exists for an improved apparatus for restoring a rail profile using a portable milling machine.

In addition, a need exists for an improved apparatus for restoring a rail profile after welding of the same that is highly accurate. Moreover, a need exists for an improved apparatus for restoring a rail profile after welding of the same that is easy to operate without causing stress or strain on an operator.

Further, a need exists for an improved apparatus for restoring a rail profile after welding of the same that reduces the possibility of improper profile restoration. Still further, a need exists for an improved apparatus for restoring a rail profile after welding of the same that reduces damage or injury caused by dust and/or sparks.

### SUMMARY OF THE INVENTION

The present disclosure provides a portable rail weld milling machine apparatus. Specifically, the portable rail weld milling machine apparatus comprises a frame or support structures that incorporates a motor with a rotary carbide tool that is able to lock to a rail or rails for stability. The apparatus houses the required guides and motors to maneuver the tool on a plurality of axes with computer numerical control (“CNC”). The CNC programming is able to control the carbide tool such that the welded rail can be milled to proper profile on the entire running surface, including the top, the field side, and the gauge side of the ball of the rail.

A picking point atop the frame is utilized to situate the apparatus over the center of a weld made in rails to be profiled. The picking point is attached to a hydraulically controlled boom affixed to a truck or rail cart. Also situated in the truck or cart is a source for both electric and hydraulic power. The apparatus allows for the proper profiling of the head of the welded rails repeatedly, while at the same time eliminating sparks typically generated by profile grinding rail welds via abrasive stones.

To this end, in an embodiment of the present invention, an apparatus for milling a first railroad rail is provided. The apparatus comprises: a support structure comprising a first clamp extending from a first side of the support structure and configured for clamping the support structure to a first railroad rail, a second clamp extending from the first side of the support structure and configured for clamping the support structure to the first railroad rail, and a third clamp extending from a second side of the support structure and configured for clamping the support structure to a second railroad rail running parallel to the first railroad rail; a first linear guide running longitudinally and parallel to the first and second railroad rails; a second linear guide running laterally and perpendicular to the first and second railroad rails, wherein the second linear guide is on the first linear guide; a support sub-structure attached to the second linear guide; and a milling tool extending from the support sub-structure comprising a railroad rail profile milling head, the milling tool comprising a vertical lifting mechanism for moving the railroad rail profile milling head vertically, wherein movement of the support sub-structure on the second linear guide allows for lateral movement of the railroad rail profile milling head laterally and movement of the support sub-structure and the second linear guide together on the first linear guide allows for longitudinal movement of the railroad rail profile milling head longitudinally.

In an embodiment, the support structure is a platform.

In an embodiment, the first linear guide comprises first and second parallel rails, wherein the second linear guide extends above the first and second parallel rails.

In an embodiment, the second linear guide comprises a third rail extending laterally above the first and second rails, wherein the support sub-structure moves along the third rail.

In an embodiment, the second linear guide comprises a fourth rail extending laterally above the first and second rails, wherein the support sub-structure moves along the fourth rail.

In an embodiment, the support sub-structure is a platform.

In an embodiment, the first linear guide comprises a first threaded rod.

In an embodiment, the second linear guide comprises a second threaded rod.

In an embodiment, the milling head extends from a motor, and the motor is attached to the support sub-structure.

In an embodiment, the milling head comprises a surface configured to mill a top of a railroad rail head and further wherein the milling head comprises a surface configured to mill a side of a rail head.

In an embodiment, the apparatus further comprises: a foot extending from the support structure, wherein the foot is configured to be raised or lowered, thereby raising or lowering the support structure when the foot engages a surface therebeneath.

In an embodiment, the foot comprises a jack for raising or lowering the support structure when the foot engages the surface therebeneath.

In an embodiment, the jack is a screw jack or a hydraulic jack.

In an embodiment, the surface is the ground or a railroad rail bed.

In an embodiment, the apparatus further comprises: a plurality of feet extending from the support structure, each of the plurality of feet configured to be raised or lowered, thereby raising or lowering the support structure when each of the plurality of feet engages a surface therebeneath.

In an embodiment, the apparatus further comprises: a first leveling platform extending from the second side of the support structure, the first leveling platform comprising a surface configured to engage a top of the second railroad rail, and a first lifting jack configured to lift the support structure relative to the top of the second railroad rail.

In an embodiment, the first lifting jack is a screw jack or a hydraulic jack.

In an embodiment, the apparatus further comprises: a second leveling platform extending from the second side of the support structure, the second leveling platform comprising a surface configured to engage a top of the second railroad rail, and a second lifting jack configured to lift the support structure relative to the top of the second railroad rail.

In an embodiment, the second lifting jack is a screw jack or a hydraulic jack.

In an embodiment, the apparatus further comprising: a control platform comprising at least one of control and power to the apparatus for controlling the milling head via the first and second linear guides and the milling tool.

It is, therefore, and advantage and objective of the present invention to provide an improved apparatus for restoring a rail profile after welding of the same.

More specifically, it is an advantage and objective of the present invention to provide an improved apparatus for restoring a rail profile using a portable rail weld milling machine.

In addition, it is an advantage and objective of the present invention to provide an improved apparatus for restoring a rail profile after welding of the same that is highly accurate.

Moreover, it is an advantage and objective of the present invention to provide an improved apparatus for restoring a rail profile after welding of the same that is easy to operate without causing stress or strain on an operator.

Further, it is an advantage and objective of the present invention to provide an improved apparatus for restoring a rail profile after welding of the same that reduces the possibility of improper profile restoration.

Still further, it is an advantage and objective of the present invention to provide an improved apparatus for restoring a rail profile after welding of the same that reduces damage or injury caused by dust and/or sparks.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a rail having a weld between rail sections in abutment to each other.

FIG. 2 illustrates a side view of a portable rail weld milling machine apparatus positioned on a rail in an embodiment of the present invention.

FIG. 3 illustrates a top view of a portable rail weld milling machine apparatus having parallel rail stabilizing arms in an embodiment of the present invention.

FIG. 4 illustrates a front view of a portable rail weld milling machine apparatus having at least one parallel rail stabilizing arm in an embodiment of the present invention.

FIG. 5 illustrates a perspective view of a milling head engaged against a railroad rail in an embodiment of the present invention.

FIG. 6 illustrates a front perspective view of a portable rail weld milling apparatus in an alternate embodiment of the present invention.

FIG. 7 illustrates a rear perspective view of a portable rail weld milling apparatus in the alternate embodiment of the present invention.

### DETAILED DESCRIPTION OF THE PRESENTLY PREFERRED EMBODIMENTS

The present disclosure provides a portable rail weld milling machine apparatus. Specifically, the portable rail weld milling machine apparatus comprises a frame or support structures that incorporates a motor with a rotary carbide tool that is able to lock to a rail or rails for stability. The apparatus houses the required guides and motors to maneuver the tool on a plurality of axes with computer numerical control (“CNC”). The CNC programming is able to control the carbide tool such that the welded rail can be milled to proper profile on the entire running surface, including the top, the field side, and the gauge side of the ball of the rail.

A picking point atop the frame is utilized to situate the apparatus over the center of a weld made in rails to be profiled. The picking point is attached to a hydraulically controlled boom affixed at the rear of a truck or cart. Also situated in the truck or cart is a source for both electric and hydraulic power. The apparatus allows for the proper profiling of the head of the welded rails repeatedly, while at the same time eliminating sparks typically generated by profile grinding rail welds via abrasive stones.

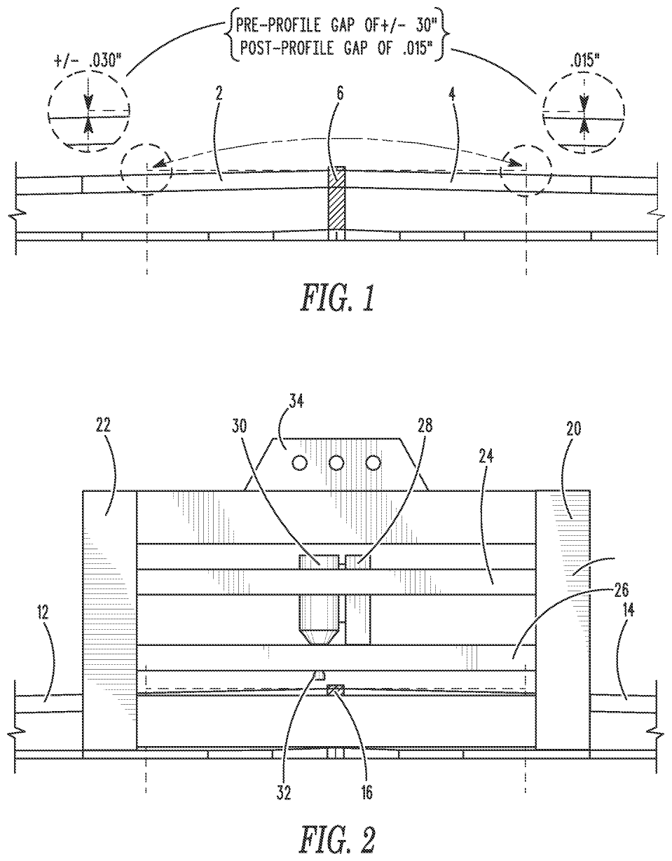

Now referring to the figures, wherein like numerals refer to like parts, FIG. 1 illustrates a side view of a first rail section 2 and a second rail section 4 in abutment, with a rail weld 6 in a weld zone disposed at the joint thereof to hold the first rail section 2 firmly with the second rail section 4. Typically, an exothermic weld joins the steel rail sections together. Although the present invention described herein is specific to butt-welds between two rail sections, it should be noted that the present invention may be utilized on other welds or irregularities in rails, and the present invention should not be limited as described herein. For example, frogs and diamonds are typically repaired by building up weld patterns on surfaces, and the present invention may be useful for milling these weld patterns to smooth, regular surfaces.

The rail weld 6, when applied between the rail sections, is typically rough, bumpy or otherwise irregular, and does not provide a smooth running surface within the rail weld zone. The rail weld 6 must typically be reduced and smoothed to provide a smooth surface for rail vehicles.

When a weld is applied to terminal ends of rail sections to join the rail sections together, the weld is typically crowned vertically higher than the linear rail head running surface prior to welding. This is because after the rail is heated from welding, the foot of the rail profile cools more rapidly than the head (being thicker than the foot) thus causing distortion. The vertically higher crown minimizes this and ensures that the running surface of the weld zone is not lower than the running surface, which would make it difficult to correct. As illustrated in FIG. 1, the rail weld 6 may have a pre-profile gap of +/−0.030″. Typically, a post-profile gap of +/−0.15″ or less is desired to ensure a smooth and safe running surface for the rail weld zone.

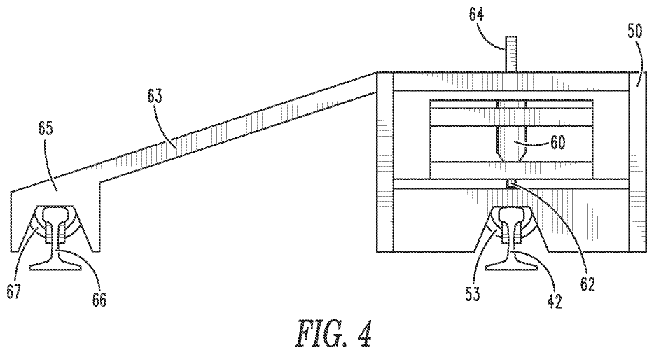

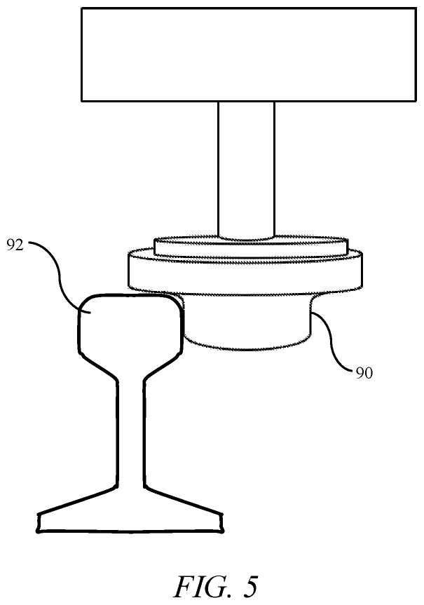

FIG. 2 illustrates a side view of a portable rail weld milling machine apparatus 10 in an embodiment of the present invention. The portable rail weld milling machine apparatus 10 may be positioned over two adjoining rail sections 12, 14 having a rail weld 16 in a rail weld zone. The portable rail weld milling machine apparatus 10 may comprise a frame 20 that may be disposed over and, preferably, clamp to a the rail sections 12, 14, stabilizing the apparatus 10 on the rail sections 12, 14, as illustrated in FIG. 4. The frame 20 may comprise legs 22 and guides 24, 26, 28 for guiding a CNC milling motor 30 and a milling tool 32 on the rail weld 16. Specifically, the milling tool 32 may engage the rail weld 6, thereby milling the rail weld 16 so that the rail weld 16 has a smooth, regular surface. The motor 30 may provide for high-speed rotation of the milling tool 32, which may preferably comprise a carbide tool. The carbide tool may have a size and shape that is useful for smoothing the rail weld 16 and the rail profile surface both on a top thereof, and on the sides of the rail head and rail profile. Specifically, cutting from the carbide tool may preferably be accomplished from both the bottom and the sides of the carbide tool simultaneously. FIG. 5 illustrates a carbide tool 90, as described herein, having a size and shape allowing the carbide tool 90 to mill a railroad rail 92 on the top and a side thereof simultaneously.

Because of the precise control of the milling tool 32 via the motor 30 on the guides 24, 26, 28, the cutting of the rail weld 6 by the milling tool 32 may provide precise smoothing, and may be done autonomously. Specifically, the rail weld 16 and the surrounding rail sections 12, 14 may be analyzed, either by an operator by sight, or via analysis thereof by an automatic system, such as a laser analysis system, to determine how much rail weld 16 to remove, and where to remove the same to provide the proper rail profile.

Specifically, in an embodiment of the present invention, a laser scanning system that may be part of the apparatus 10, or alternatively may be a stand-along system or associated with a different apparatus, may scan the rail weld 16 and the surrounding rail sections 12, 14 to obtain a detailed record of the state of the rail weld. The system may further analyze the scan results to determine where to remove rail weld material and how much to remove to achieve the smooth, regular surface that is necessary. Of course, other probes or scanning systems may be utilized to measure rail welds, and the present invention should not be limited as described herein.

Moreover, the system of the present invention may further retain a record of the scanned results that may be stored for future use. After it is determined how much weld material to remove and from where on the rail weld 16, the milling tool 32 may engage the rail weld 16 and remove the material as provided by either the operator or the system automatically on a plurality of axes (such as, for example, 3 axes or 4 axes, as necessary) using computer numerical control (CNC). The milling tool 32 may move in three dimensions via the guides 24, 26, 28, or other guides not shown, to remove weld material from the top and sides of the rail weld in the head portion of the rail weld zone. After the material is removed, the rail weld may be visually inspected, or scanned again to determine if the proper amount of rail weld material has been removed, or whether further milling is necessary.

As illustrated in FIG. 2, a picking point 34 on a top of the frame 20 may have a connector for connecting to a boom or transfer arm (not shown) that may be disposed on a truck or cart. The boom or transfer arm may allow an operator to easily control placement and/or removal of the apparatus 20 onto the rail at the rail weld 16. Preferably, the boom or transfer arm may be guided by an operator and precisely placed in a proper location, as needed. In addition, the boom or transfer arm may further provide distribution of electric and hydraulic power to the apparatus 10 from a truck or cart, as needed in the operation of the apparatus 10. Of course, it should be noted that a boom or transfer arm may not be necessary, and the apparatus 10 may be a stand-alone apparatus that may be placed on rail sections by operators thereof.

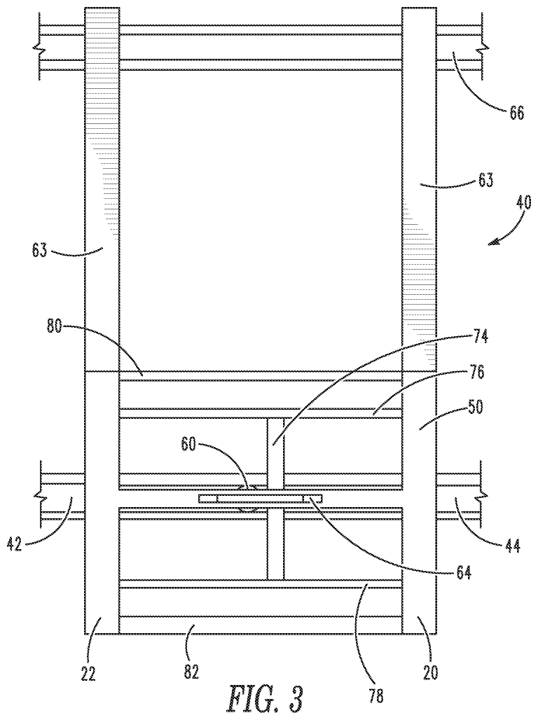

Referring now to FIGS. 3 and 4, an alternate embodiment of the present invention is disclosed. Specifically, a portable rail weld milling machine apparatus 40 is illustrated having a frame 50, including lateral bridging elements 80, 82 spanning between legs 20, 22 forming the frame 50, with a motor 60 and milling tool 62, as described above. The motor 60 and milling tool 62 may be attached to a linear guide 74 disposed and configured laterally to rail sections 42, 44. Moreover, the linear guide 74 may allow the motor 60 and milling tool 62 to traverse in a direction lateral to the rail sections 42, 44. The linear guide may further be attached to longitudinal linear guides 76, 78 disposed on opposite sides of rail sections 42, 44 and configured longitudinal to the rail sections 42, 44, allowing the motor 60 and milling tool 62 to move longitudinal to the rail sections 42, 44. The motor 60 and milling tool 62 may further be attached to a vertical linear guide (not shown in FIG. 3) allowing the motor 60 and milling tool 62 to move upwardly and downwardly as needed. Finally, the motor 60 and milling tool 62 may be rotatably connected to the vertical linear guide (not shown) so that the motor 60 and milling tool 62 may rotate in a lateral direction, allowing the milling tool 62 to be positioned in any position between vertical and horizontal to be able to mill sides of the rail sections 42, 44 and components thereof.

The frame 50 may have one or more clamps 53 disposed thereunder for clamping the frame 50 to rail sections the 42, 44 with the rail weld therebetween. The picking point 64 with the connector may be connected to a boom or transfer arm (not shown) for ease of moving the same, although, again, the apparatus 40 may be a stand-alone apparatus moved into position by operators without the aid of a boom or transfer arm. Extending from a side of the frame 50 may be one or more arms 63, each having a housing 65 on an end thereof with a clamp 67 that may engage a rail 66 disposed parallel to the rail sections 42, 44, thus providing enhanced stability for the apparatus 40 as it mills the rail weld 46.

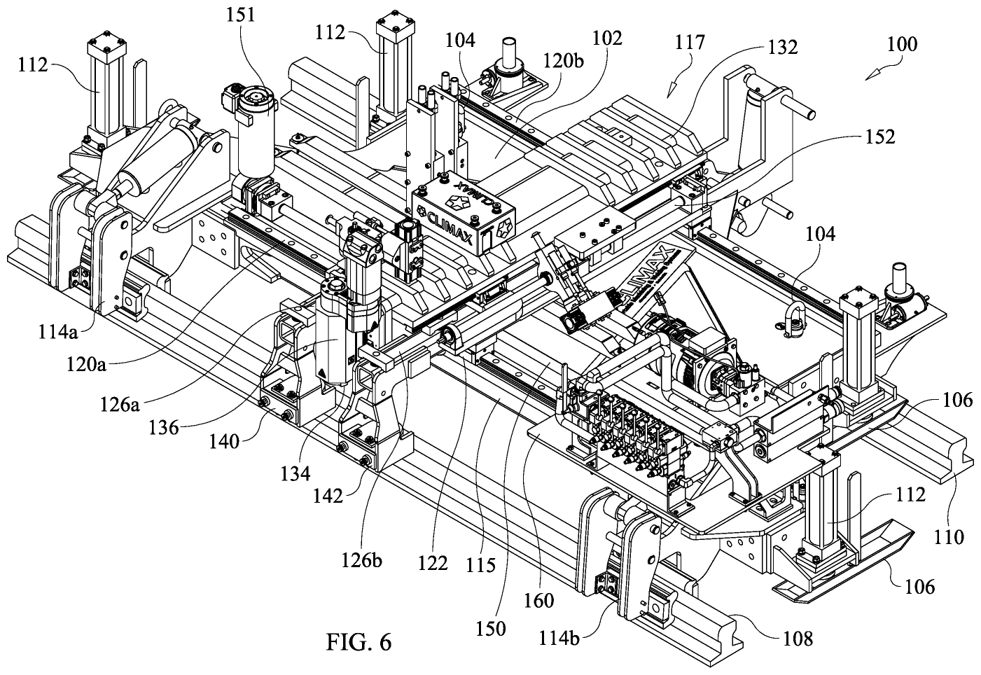

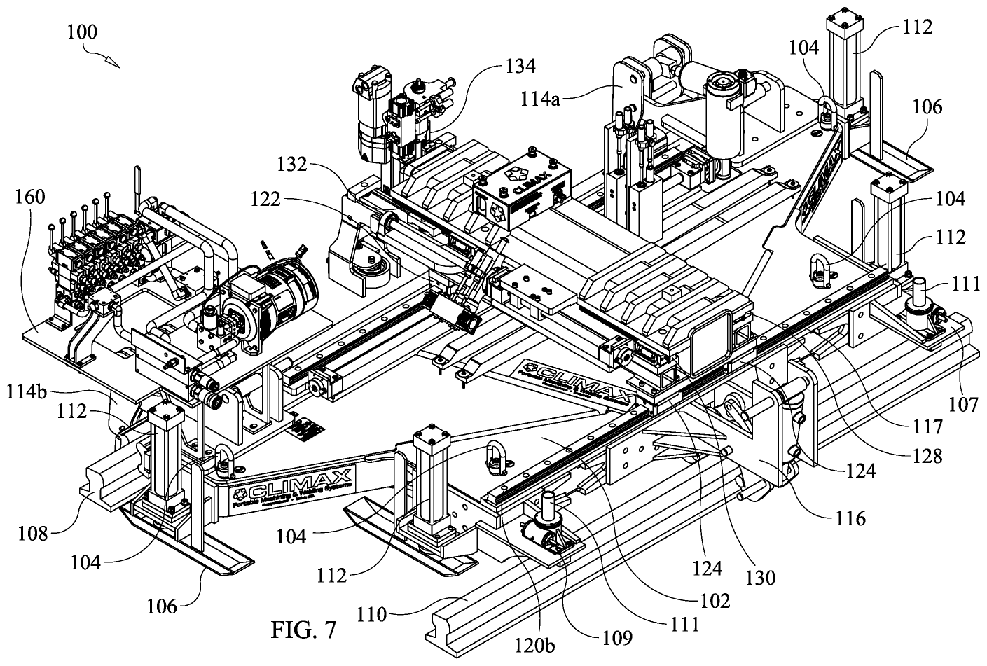

In an alternate embodiment of the present invention, illustrated herein in FIGS. 6-7 and described hereinbelow, a portable rail weld milling machine apparatus 100 is presented. The apparatus 100 comprises a support structure 102 on which several elements are disposed for allowing a railroad rail having a weld thereon (or any other imperfection) to be milled, as described herein. The support structure 102 may be a platform, as shown in FIGS. 6 and 7, a frame, or other like structure on which the other elements described herein may be disposed.

A plurality of attachment points 104 may be spaced around the support structure 102 that may be useful for picking up the support structure 102, such as via a crane (not shown) or the like, for placement on a railroad bed and/or for removal therefrom. As illustrated in FIGS. 6 and 7, attachment points 104 may be rings that may extend from the platform for connection thereto by the crane. The crane may be movable, such as mounted on a truck for transporting the milling apparatus 100 to a rail for milling thereof, such as via the railroad rails, via road, or otherwise.

Disposed in various locations on the support structure 102 may be a plurality of feet 106 on which the support structure may rest when the feet 106 are in contact with the ground or the railroad rail bed. For example, the apparatus 100 may be placed between a pair of rails 108, 110, and the plurality of feet 106 may contact the rail bed on which the railroad rails run. The feet may be sufficient in number and placement to hold the support structure 102 thereon in a balanced manner. The feet may have lifts or jacks 112 thereon, such as threaded rods or hydraulic cylinders, which may allow the feet to be placed in position and lift or otherwise move the support structure 102 into position where necessary for milling a rail.

A pair of lifting and leveling assemblies 107, 109, which may be platforms, may extend from the support structure 102, as illustrated in FIG. 7, and may be positioned above rail 110 to further aid in positioning of the apparatus 100 for milling the rail 108. Specifically, assemblies 107, 109 may each have a screw jack or hydraulic jack 111 or other lifting mechanism that may engage the top of the head of the rail 110 to push the apparatus 100 in the vertical direction for precise positioning of the apparatus prior to milling thereof.

Once the support structure 102 is placed in position between rails 108, 110, as illustrated in FIG. 6, and the support structure 102 is lifted and/or leveled via the feet 106 and/or the lifting and leveling assemblies 107, 109, then first and second front clamps 114a, 114b may clamp to rail 108, and back clamp 116 may clamp to rail 110. The first and second front clamps 114a, 114b may be disposed on or extending from opposite ends on a first side 115 of the support structure 102 such that they are positioned on opposite sides of a weld or other aberration on rail 108. Back clamp 116 may be disposed on or extend from a second side 117 of the support structure 102 such that it forms a tripod support for the support structure, thereby locking the support structure rigidly in place on the rails 108, 110. Preferably, the first and second front clamps 114a, 114b and the back clamp 116 may be hydraulically powered and easily controlled by a user, such that the apparatus 100 may be clamped to the rails 108, 110 for milling the rail 108.

The support structure 102 may further comprise first and second rails 120a, 120b that extend and run parallel to the railroad rails 108, 110 on which run carriages 122 and 124. Carriages 122, 124 may support third and fourth rails 126a, 126b that may extend laterally from first rail 120a to second rail 120b, and may support carriages 128 and 130. Third and fourth rails 126a, 126b may be parallel to each other and perpendicular to first and second rails 120a, 120b and rails 108, 110. Carriages 128 and 130 may support a sub-platform 132 on which may be disposed a railroad rail milling tool 134. The railroad rail milling tool 134 may be positioned on an end of the sub-platform 132 such that the railroad rail milling tool 134 is placed in the proper position to mill the railroad rail 108.

Thus, the sub-platform 132 and, therefore, the railroad rail milling tool 134 may move longitudinally by movement along the first and second rails 120a, 120b. Likewise, the sub-platform 132 and the railroad rail milling tool 134 may move laterally by movement along the third and fourth rails 126a, 126b.

The railroad rail milling tool 134 may comprise a milling head 90 as illustrated in FIG. 5, having a profile that may be mill both a top of a rail 92, 108 and a side thereof at the same time. The railroad rail milling tool 134, comprising the milling head as described herein, may comprise a lifting mechanism 136 such that the railroad rail milling tool 134 may move in the vertical direction so that the same may be precisely positioned on the head and the side of railroad rail 108 during milling thereof. The lifting mechanism may comprise a threaded rod, a hydraulic cylinder, or other like mechanism for moving the railroad rail milling tool 134 and, specifically, the milling head 90 up or down as necessary. Thus, with movement of the railroad rail milling tool 134 in the longitudinal and lateral directions, as described above, and in the vertical direction, the railroad rail milling tool 134 may move in three dimensions in space such that the railroad rail 108 may be precisely milled. Before use, the railroad rail milling tool 134 may be precisely placed on the rail head of the rail 108 via lateral, longitudinal and/or vertical movements thereof, and during use, the railroad rail milling tool 134 may move longitudinally down the railroad rail 108 milling the top and/or side of the railroad rail 108.

For example, the railroad rail milling tool 134 may be positioned to mill the railroad rail 108 on an outside thereof, i.e., the “field” side of the railroad rail. Alternatively, the rail milling tool 134 may be positioned to mill the rail 108 on an inside thereof, i.e., the “gauge” side of the railroad rail.

A pair of rollers 140, 142 may extend the sub-platform 132 and maybe positioned on a side of the railroad rail 108 opposite the side to be milled by the railroad rail milling tool 134. Specifically, if the railroad rail milling tool 134 is to mill the gauge side of the railroad rail 108, then the rollers 140, 142 may be positioned to contact the field side of the railroad rail 108. Alternatively, if the railroad rail milling tool 134 is to mill the field side of the railroad rail 108, then the rollers 140, 142 may be positioned to contact the gauge side of the railroad rail 108. The rollers may provide a counter-force against the railroad rail 108 to the railroad rail milling tool 134 during milling thereof to better engage the railroad rail milling tool 134 and, mores specifically, the milling head 90 against the railroad rail during milling of the railroad rail 108, thereby reducing vibrations and providing a more precise milling thereof.

Movement of carriages 122, 124 on rails 120a, 120b may be done via any mechanism. As shown in FIGS. 6 and 7, a longitudinal threaded rod 150 may extend longitudinally on the support structure, and a motor may turn the threaded rod to move the carriages 122, 124 thereon. Likewise, a lateral threaded rod 152 may extend laterally and may be disposed on the sub-platform 132 to move the carriages 128, 130 and, therefore, the sub-platform 132, laterally via a motor thereon. Thus, precise control of the longitudinal and lateral movement of the sub-platform 132 and, thus, the railroad rail milling tool 134, may be achieved.

A control platform 160 may be mounted on the support structure 102 and may supply the necessary controls to the various parts of the apparatus 100. Specifically, computer control of the motors and hydraulics may be achieved via the control platform 160. Power, such as electrical power and/or hydraulic power, may be supplied through an umbilical cable that may be attached to the apparatus 100 from a source thereof, such as the truck that delivered the apparatus to the rail for milling thereof. Alternatively, power may be generated and/or supplied via components on the control platform 160 without an umbilical cable or any other supply from the truck, thereby providing sufficient electrical and/or hydraulic power to the components of the apparatus 100.

Thus, the embodiments of the present invention disclosed herein provide quality control and quality assurance for the railroad rail profiles that have been welded together, or for any other imperfection on a railroad rail, thereby ensuring that the rail profiles are sufficiently smooth and regular for rail vehicles to roll thereon without danger or risk. The milling process may be precisely controlled, and may prevent or reduce the creation of dust or sparks, reducing or eliminating the need for special breathing protection and protective gear by operators thereof. Automatic milling of the rail weld provides a more accurate finished profile, and eliminates stress and strain on operators. Indeed, operators may perform other tasks during the milling thereof. Moreover, dimensional records of the railroad rail weld, pre-profile and post-profile, may be maintained and stored for quality and safety.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An apparatus for milling a first railroad rail comprising:
a support structure comprising a first clamp extending from a first side of the support structure and configured for clamping the support structure to a first railroad rail, a second clamp extending from the first side of the support structure and configured for clamping the support structure to the first railroad rail, and a third clamp extending from a second side of the support structure and configured for clamping the support structure to a second railroad rail running parallel to the first railroad rail;
a first linear guide running longitudinally and parallel to the first and second railroad rails;
a second linear guide running laterally and perpendicular to the first and second railroad rails, wherein the second linear guide is on the first linear guide;
a support sub-structure attached to the second linear guide; and
a milling tool extending from the support sub-structure comprising a railroad rail profile milling head, the milling tool comprising a vertical lifting mechanism for moving the railroad rail profile milling head vertically,
wherein movement of the support sub-structure on the second linear guide allows for lateral movement of the railroad rail profile milling head laterally and movement of the support sub-structure and the second linear guide together on the first linear guide allows for longitudinal movement of the railroad rail profile milling head longitudinally.

2. The apparatus of claim 1 wherein the support structure is a platform.

3. The apparatus of claim 1 wherein the first linear guide comprises first and second parallel rails, wherein the second linear guide extends above the first and second parallel rails.

4. The apparatus of claim 3 wherein the second linear guide comprises a third rail extending laterally above the first and second rails, wherein the support sub-structure moves along the third rail.

5. The apparatus of claim 4 wherein the second linear guide comprises a fourth rail extending laterally above the first and second rails, wherein the support sub-structure moves along the fourth rail.

6. The apparatus of claim 1 wherein the support sub-structure is a platform.

7. The apparatus of claim 1 wherein the first linear guide comprises a first threaded rod.

8. The apparatus of claim 7 wherein the second linear guide comprises a second threaded rod.

9. The apparatus of claim 1 wherein the milling head extends from a motor, and the motor is attached to the support sub-structure.

10. The apparatus of claim 1 wherein the milling head comprises a surface configured to mill a top of a railroad rail head and further wherein the milling head comprises a surface configured to mill a side of a rail head.

11. The apparatus of claim 1 further comprising:
a foot extending from the support structure, wherein the foot is configured to be raised or lowered, thereby raising or lowering the support structure when the foot engages a surface therebeneath.

12. The apparatus of claim 11 wherein the foot comprises a jack for raising or lowering the support structure when the foot engages the surface therebeneath.

13. The apparatus of claim 12 wherein the jack is a screw jack or a hydraulic jack.

14. The apparatus of claim 11 wherein the surface is the ground or a railroad rail bed.

15. The apparatus of claim 1 further comprising:
a plurality of feet extending from the support structure, each of the plurality of feet configured to be raised or lowered, thereby raising or lowering the support structure when each of the plurality of feet engages a surface therebeneath.

16. The apparatus of claim 1 further comprising:
a first leveling platform extending from the second side of the support structure, the first leveling platform comprising a surface configured to engage a top of the second railroad rail, and a first lifting jack configured to lift the support structure relative to the top of the second railroad rail.

17. The apparatus of claim 15 wherein the first lifting jack is a screw jack or a hydraulic jack.

18. The apparatus of claim 15 further comprising:
a second leveling platform extending from the second side of the support structure, the second leveling platform comprising a surface configured to engage a top of the second railroad rail, and a second lifting jack configured to lift the support structure relative to the top of the second railroad rail.

19. The apparatus of claim 17 wherein the second lifting jack is a screw jack or a hydraulic jack.

20. The apparatus of claim 1 further comprising:
a control platform comprising at least one of control and power to the apparatus for controlling the milling head via the first and second linear guides and the milling tool.
